(19) United States
(12) Patent Application Publication
(10) Pub. No.: US 2020/0111027 A1
(43) Pub. Date: Apr. 9, 2020

(54) SYSTEMS AND METHODS FOR PROVIDING RECOMMENDATIONS BASED ON SEEDED SUPERVISED LEARNING

(71) Applicant: BEIJING DIDI INFINITY TECHNOLOGY AND DEVELOPMENT CO., LTD., Beijing (CN)

(72) Inventors: Zhiwei QIN, Beijing (CN); Chengxiang ZHUO, Beijing (CN); Wei TAN, Beijing (CN); Jun XIE, Beijing (CN)

(73) Assignee: BEIJING DIDI INFINITY TECHNOLOGY AND DEVELOPMENT CO., LTD., Beijing (CN)

(21) Appl. No.: 16/703,955

(22) Filed: Dec. 5, 2019

Related U.S. Application Data
(63) Continuation of application No. PCT/CN2017/087220, filed on Jun. 5, 2017.

(51) Int. Cl. G06N 20/00; G06Q 50/00; G06Q 30/02

(52) U.S. Cl. CPC G06N 20/00; G06Q 50/01; G06Q 30/0269; G06Q 30/0261; G06Q 30/0255

(57) ABSTRACT

Systems and methods for providing recommendations based on seeded supervised learning are disclosed. The method may include acquiring, through a communication network, similarity data associated with a first entity, a second entity, and a third entity, and acquiring, through the communication network, external data associated with the first entity and the second entity. The method may further include training a classification model based on the external data and the similarity data. The method may also include determining an expectation score of the third entity based on classification model, and providing, through the communication network, a recommendation based on the expectation score to the third entity.

### CROSS-REFERENCE TO RELATED APPLICATION

This application is a continuation of International Application No. PCT/CN2017/087220, filed on Jun. 5, 2017, the entire contents of which are incorporated herein by reference.

### TECHNICAL FIELD

The present disclosure relates to big data and machine learning techniques, and more particularly, to systems and methods for providing recommendations based on seeded supervised learning.

### BACKGROUND

Due to recent advancements in computer technology and the popularity of the Internet, large numbers of people have started to use platforms that utilize databases. Because of this, these databases often require the use of“big data” analytics. Big data analytics is the process of examining “big data,” that is, large or complex collections of data in order to uncover hidden patterns, user behaviors, market trends, customer preferences, and other useful information. “Big data” is often stored in a database management system (e.g., Oracle®, Teradata®, PostgreSQL, Microsoft SQL Server, and MySQL™ database management systems), which are not equipped to analyze these data sets.

Analyzing the big data manually or even semi-automated ways can be labor intensive. For example, a company may hire a team of engineers to come up with a solution to provide intelligent recommendations to the users of a social network in order to efficiently acquire new customers with minimal costs. These social networks may include a company's existing customers as well as potential customers. By using these social networks, one may learn behaviors of potential customers based on information related to existing customers.

However, social network data are often large in size, and the existing techniques to analyze social network data are often inadequate, inefficient, and do not fully exploit the hidden patterns, user behaviors, market trends, customer preferences, and other useful information embedded within the data.

In view of these and other shortcomings and problems with big data analytics, improved systems and methods for providing recommendations using machine learning, and more particularly, seeded supervised learning are needed.

### SUMMARY

One aspect of the disclosure provides a system for providing a recommendation to an entity. The system may include a memory and a processor. The processor may be configured to acquire similarity data associated with a first entity, a second entity, and a third entity, and acquire external data associated with the first entity and the second entity. The processor may be further configured to train a classification model based on the external data and the similarity data. The processor may also be configured to determine an expectation score of the third entity based on the classification model, and provide a recommendation based on the expectation score to the third entity.

Another aspect of the disclosure provides a computer-implemented method for providing a recommendation to an entity. The method may include acquiring, through a communication network, similarity data associated with a first entity, a second entity, and a third entity, and acquiring, through the communication network, external data associated with the first entity and the second entity. The processor may be further configured to training a classification model based on the external data and the similarity data. The processor may also be configured to determining an expectation score of the third entity based on the classification model, and providing, through the communication network, a recommendation based on the expectation score to the third entity.

Yet another aspect of the disclosure provides a non-transitory computer-readable medium. The non-transitory computer-readable medium stores a set of instructions, when executed by at least one processor of a recommendation system, cause the recommendation system to perform a method for providing a recommendation to an entity. The method includes acquiring similarity data associated with a first entity, a second entity, and a third entity, and acquiring external data associated with the first entity and the second entity. The method may further include training a classification model based on the external data and the similarity data. The method may also include determining an expectation score of the third entity based on the classification model; and providing a recommendation based on the expectation score to the third entity.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 illustrates a schematic diagram of an exemplary system for providing recommendations based on seeded supervised learning, according to some embodiments of the disclosure.

FIG. 2 is a block diagram of an exemplary system for providing recommendations based on seeded supervised learning, according to some embodiments of the disclosure.

FIG. 3 illustrates a graph diagram of an exemplary social network, according to some embodiments of the disclosure.

FIG. 4 is a flowchart of an exemplary process for providing recommendations based on seeded supervised learning.

FIG. 5 is a flowchart of an exemplary process for training a classification model, according to some embodiments of the disclosure.

FIG. 6 is a flowchart of an exemplary process for determining a seed for a transition model, according to some embodiments of the disclosure.

### DETAILED DESCRIPTION

The present disclosure provides novel systems and methods for providing recommendations based on seeded supervised learning. Specifically, the disclosed systems and methods provide intelligent recommendations to the users of a social network in order to acquire new customers through machine learning. Machine learning trains computers to learn without specifically having to program them, such as to perform pattern recognition or artificial intelligence. Specifically, this disclosure utilizes semi-supervised learning, using a small amount of known characteristics for a small amount of data to predict the characteristics of a large amount of data. The disclosed systems and methods improve existing computer systems by providing new systems and methods to train computer systems in novel ways. For example, one aspect of the disclosed embodiments provides new systems and methods to provide intelligent recommendations for a large set of users based on characteristics of a small set of users. To provide these improvements, the disclosed systems and methods may be implemented using a combination of hardware, firmware, and/or software, as well as specialized hardware, firmware, and/or software, such as a machine constructed and/or programmed specifically for performing functions associated with the disclosed method steps. However, in some embodiments, disclosed systems and methods may be implemented instead in dedicated electronics.

According to disclosed embodiments, the system for providing a recommendation to an entity may include a processor and a memory device storing instructions. An entity, as noted by this disclosure, may be any person, group of people, organization, place, or object that has a relationship with another entity. Although embodiments in this disclosure are described using a person associated with one or more social networks as an exemplary entity, it is contemplated that the embodiments may be adapted for other types of entity. In some embodiments, a social network may be formed by entities or users communicating with each other on a dedicated website or other application that enables entities or users to post information, comments, messages, videos, images, or the like. In other embodiments, the social network may be formed by entities or customers utilizing a business platform, where some or all of the relationships on the business platform are between the entities and the business.

In some embodiments, the processor of the system may be configured to acquire, through a communication network, similarity data associated with multiple entities. Similarity data is data representative of a comparison between two or more entities. For example, similarity data may include data that is indicative of the frequency of communication between entities (i.e., communication frequency), a comparison of how entities present themselves to the social network (i.e., a profile similarity), a comparison of the professional careers of the entities (i.e., work similarity), a comparison of the geolocation of two entities (i.e., a proximity similarity), a rate or amount of currency exchanged between two entities (i.e. exchange of currency similarity), a comparison between services that each entity have recommended (i.e. recommended similarity), or the like.

Additionally, the processor may be configured to acquire, through the communication network, external data associated with the subset of those entities. The subset of entities may be, e.g., existing customers, and therefore, associated external data can be collected. For example, external data may include a page rank score associated with an activity performed by both the first entity and the second entity. A page rank score for an entity may come from a graph-based algorithm, called PageRank, that was originally used to rank websites by their relative importance to the web. Since the invention of PageRank, social networking companies have used PageRank to rank people using a social network to identify their relative importance on a particular social networking platform. An entity may have external data that has a page rank score associated with an external source. The disclosed embodiments utilize the external data to provide a recommendation for other entities connected to the entity with the external data.

The processor of the system may be further configured to train a classification model based on the external data and the similarity data. To train the classification model, the processor of the system may be further configured to determine a seed link based on the external data. A seed link may represent the relationship between two or more seeds or entities that have strong relationships with external sources. A seed link may either positive or negative. That is, a positive seed link may identify two seeds that have a strong relationship to each other while a negative seed may identify two seeds that have a weak relationship to each other. Determining a seed link based on the external data may further include determining a first seed based on the external data of the first entity, determining a second seed based on the external data of the second entity, and determining a seed link between the first and second seeds based on the external data of the first entity, the external data of the second entity, and a predetermined value.

After determining the seed link based on the external data, in some embodiments, the processor of the system may be configured to determine a relationship strength based on the similarity data and the seed link. A relationship strength may be defined as the relationship strength between two seeds relative to the other entities. Determining a relationship strength based on the similarity data and the seed link may further include training a classification model to learn the relationship weights using a seed link and the similarity data. The classification model may be stored in memory and is trained using supervised or semi-supervised machine learning techniques.

In some embodiments, the system may be further configured to determine an expectation score of an entity based on the classification model and provide a recommendation based on the expectation score to the entity. For example, this entity may be a potential customer and therefore, no associated external data has existed yet. Since the entity has no external data, the expectation score may be a predictor of the likelihood that the entity may use or consider a recommendation that the seed entities (e.g., existing customers) use or consider. In some embodiments, the external data is associated with an external source that is associated with the recommendation provided. A recommendation may be an advertisement, an invitation, a promotion or offer for discount, an offer to buy something, or the like for a business or social networking. Additionally, the entity's expectation score may also be compared with the expectation scores of other entities. In some embodiments, the processor may be configured to provide the recommendation to one or more entities with the highest expectation scores amongst all of the entities.

Reference will now be made in detail to exemplary embodiments, examples of which are illustrated in the accompanying drawings and disclosed herein. Wherever convenient, the same reference numbers will be used throughout the drawings to refer to the same or like parts.

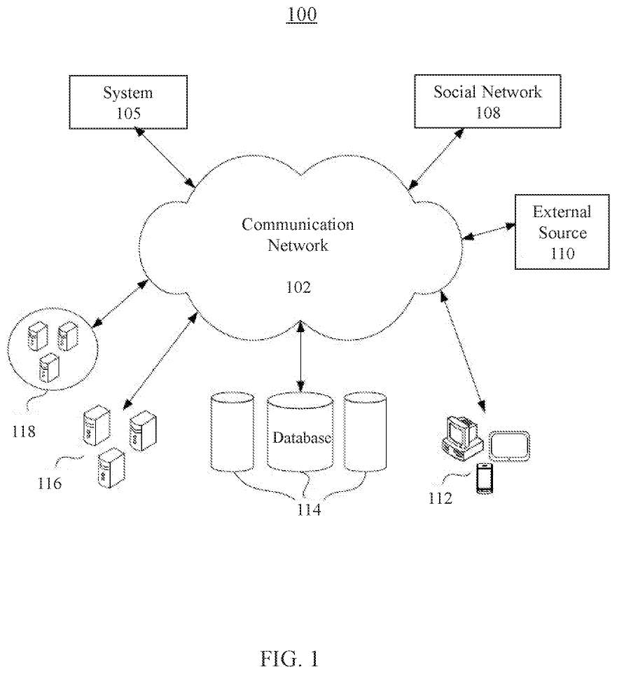

FIG. 1 illustrates a schematic diagram of an exemplary system environment 100 for providing recommendations based on seeded supervised learning, according to some embodiments of the disclosure.

Referring to FIG. 1, system environment 100 may include various components, such as communication network 102, system 105, social network(s) 108, external source(s) 110, device terminal(s) 112, database(s) 114, server cluster(s) 116, and cloud services 118. These various components may be implemented using a variety of different equipment, such as supercomputers, servers, personal computers, mobile devices like smartphones and tablets, etc. Furthermore, these components may comprise hardware, software, and/or firmware modules.

As shown in FIG. 1, communication network 102 may comprise one or more interconnected wired or wireless data networks that receive data from one service or device (e.g., system 105) and send it to another service or device (e.g., social network 108, external source 110, device terminal 112, database 114, servers cluster 116, and cloud service 118). For example, communication network 102 may be implemented as one or more of the Internet, a wired Wide Area Network (WAN), a wired Local Area Network (LAN), a wireless LAN (e.g., IEEE 802.11, Bluetooth, etc.), a wireless WAN (e.g., WiMAX), and the like. Each component in system environment 100 may communicate bi-directionally with other system environment 100 components either through communication network 102 or through one or more direct communication links (not all are shown).

System 105 may be configured to provide recommendations based on seeded supervised learning. In some embodiments, system 105 may acquire data from social network 108 or external source 110. Also, in some embodiments, the data from social network 108 or external source 110 may be stored on system 105. In some embodiments, a social network 108 may be formed by entities or users communicating with each other on a dedicated website or other application that enables entities or users to post information, comments, messages, videos, images, or the like. In other embodiments, social network 108 may be formed by entities or customers utilizing a business platform, where some or all of the relationships on the business platform are between the entities and the business. An entity, as noted by this disclosure, may be any person, group of people, organization, place, or object that has a relationship with another entity. Although embodiments in this disclosure are described using a person associated with one or more social networks as an exemplary entity, it is contemplated that the embodiments may be adapted for other types of entity. As discussed above, social network 108 may supply data to system 105. This data may include similarity data associated with each entity of social network 108. Similarity data is data representative of a comparison between two or more entities.

External source 110 may be a company, business, or a website facilitating another social network. In some embodiments, external source 110 may be associated with the same d social network 108, in others, different. Regardless, like social network 108, external source 110 may supply data to system 105. This data may include external data for a subset of the entities in social network 108.

Device terminal 112 may be a supercomputer, a server, a personal computer, a mobile device like a smartphone and a tablet. Device terminal 112 may be configured to receive input from a user to transmit to system 105. Device terminal 112 may also receive input from system 105. For example, system 105 may cause device terminal 112 to alert the user by sending a notification to a user or any other way that is ascertainable to one of ordinary skilled in the art.

Database 114 may be configured to store information consistent with the disclosed embodiments. In some aspects, components of system environment 100 (shown and not shown) may be configured to receive, obtain, gather, collect, generate, or produce information to store in database 114. In certain embodiments, for instance, components of system environment 100 may receive or obtain information for storage over communication network 102. By way of example, database 114 may store data associated with one or more entities. In other aspects, components of system environment 100 may store information in databases 114 without using a communication network 102 (e.g., via a direct connection). In some embodiments, components of system environment 100, including but not limited to system 105, may use information stored within database 114 for processes consistent with the disclosed embodiments.

Server cluster 116 may be located in the same data center or different physical locations. Multiple server clusters 116 may be formed as a grid to share resources and workloads. Each server cluster 116 may include a plurality of linked nodes operating collaboratively to run various applications, software modules, analytical modules, rule engines, etc. Each node may be implemented using a variety of different equipment, such as a supercomputer, personal computer, a server, mainframe computer, a mobile device, or the like. In some embodiments, the number of servers and/or server clusters 116 may be expanded or reduced based on workload.

Cloud service 118 may include a physical and/or virtual storage system associated with cloud storage for storing data and providing access to data via a public network such as the Internet. Cloud service 118 may include cloud services such as those offered by, for example, Amazon, Apple, Cisco, Citrix, IBM, Joyent, Google, Microsoft, Rackspace, Salesforce.com, and Verizon/Terremark, or other types of cloud services accessible via communication network 102. In some embodiments, cloud service 118 comprises multiple computer systems spanning multiple locations and having multiple databases or multiple geographic locations associated with a single or multiple cloud storage service(s). As used herein, cloud service 118 refers to physical and virtual infrastructures associated with a single cloud storage service. In some embodiments, cloud service 118 manages and/or stores data associated with providing a recommendation for an entity.

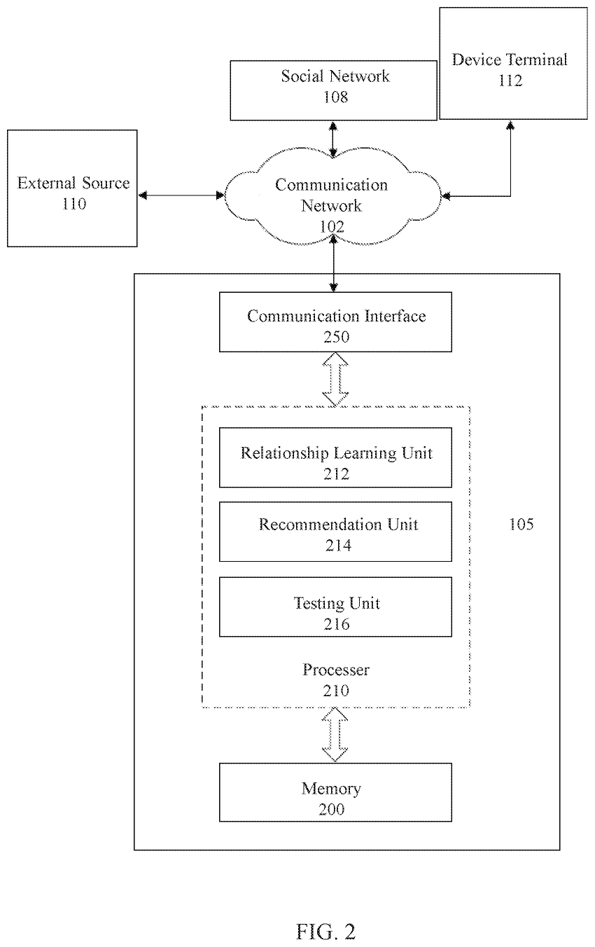

FIG. 2 is a block diagram of an exemplary system 105 for providing recommendations based on seeded supervised learning, according to some embodiments of the disclosure. As shown in FIG. 2, system 105 may include a memory 200, a processor 210, and a communication interface 250. Processor 210 may further include multiple modules, such as a relationship learning unit 212, a recommendation unit 214, and a testing unit 216. These modules (and any corresponding sub-modules or sub-units) can be functional hardware units (e.g., portions of an integrated circuit) of processor 210 designed for use with other components or a part of a program (stored on a computer-readable medium) that, when executed by processor 210, performs one or more functions. Although FIG. 2 shows units 212-216 all within one processor 210, it is contemplated that these units may be distributed among multiple processors located near or remotely with each other. System 105 may be implemented in cloud service 118, on terminal device 102, or a separate computer/server (e.g., server clusters 116). In some embodiments, one or more of these modules may be combined.

System 105 may provide a recommendation in two stages. In a first stage, also referred to as the “training stage,” system 100 may generate and train a classification model using data associated with social network 108 and external source 110; and in a second stage, also referred to as the “recommendation stage,” system 100 may apply the trained relationship model to provide a recommendation for an entity.

Communication interface 250 may establish one or more sessions for communication with social network 108, external source 110, and device terminal 112 via communication network 102. In some embodiments, communication interface 250 may continuously receive data from social network 108, external source 110, and device terminal 112 via communication network 102. Further, communication interface 250 may transmit data between any of social network 108, external source 110, and device terminal 112, and any of relationship learning unit 212, recommendation unit 214, and testing unit 216 via communication network 102.

Relationship learning unit 212 may perform part of the training stage, that is, relationship learning unit 212 may generate and train a classification model using data associated with social network 108 and external source 110. In some embodiments, relationship learning unit 212 may acquire, through communication network 102, similarity data associated with a number of entities. Additionally, relationship learning unit 212 may acquire, through communication network 102, external data associated with a subset of entities. In some embodiments, relationship learning unit 212 may train a classification model based on the acquired information of the entities, including the external data and the similarity data.

Recommendation unit 214 may perform part of the recommendation stage, which provides a recommendation to one or more entities using the classification model trained through the training stage and similarity data for the one or more entities. For example, recommendation unit 214 may determine an expectation score of one or more entities based on the classification model. Recommendation unit 214 may also provide, through communication network 102, a recommendation based on the expectation score to one or more entities. In some embodiments, the one or more entities may not have any external data.

Testing unit 214 may monitor or test a classification model, such as the classification model trained by relationship learning unit 212. For example, testing unit 214 may test to see if the model mathematically converges. If it does not mathematically converge, the classification model may cause system 105 to send a notification to device terminal 112 over communication network 102 concerning this issue. A classification model that does not mathematically converge may not be used; therefore, testing unit 214 may cause system 105 to disregard the previously trained model and train a new classification model. Additionally, in some embodiments, testing unit 214 may monitor or test a classification model while relationship learning unit 212 trains the classification model. However, in other embodiments, testing unit 214 may only monitor or test a classification model after relationship learning unit 212 has trained the classification model.

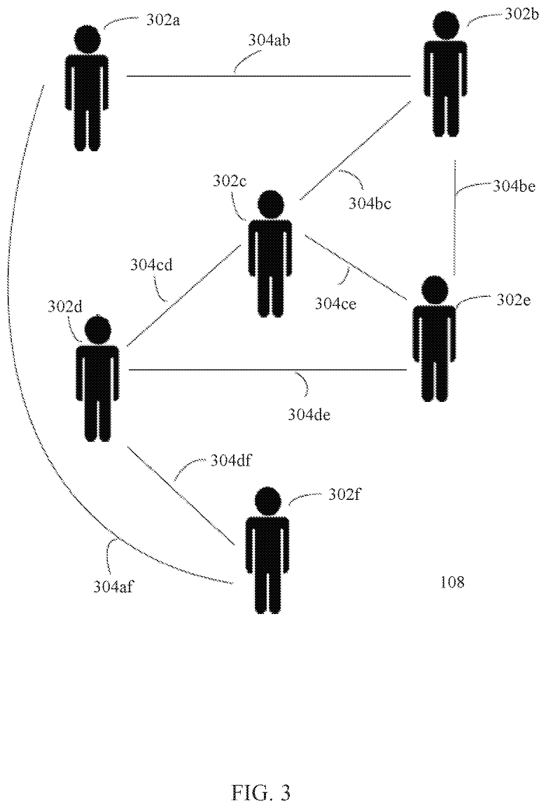

FIG. 3 illustrates a graph diagram of an exemplary social network 108, according to some embodiments of the disclosure. As shown in FIG. 3, social network 108 may include a plurality of entities, for example, 302a-302f. An entity, as noted by this disclosure, may be any person, group of people, organization, place, or object that has a relationship with another entity. Although embodiments in this disclosure are described using a person associated with one or more social networks as an exemplary entity, it is contemplated that the embodiments may be adapted for other types of entity. In some embodiments, a social network 108 may be formed by entities or users communicating with each other on a dedicated website or other application that enables entities or users to post information, comments, messages, videos, images, or the like. In other embodiments, the social network 108 may be formed by entities or customers utilizing a business platform, where some or all of the relationships on the business platform are between the entities and the business.

Each entity 302a-302f may also have a relationship 304ab-304df with another entity. Consistent with the disclosure, relationship 304ij denotes a relationship between entity 302i and 302j, where i and j=a, b, c, d, e, f, g, and f. The relationship between a set of two entities, e.g., 302a and 302b, may be weaker or stronger than the relationship between another set of two entities, e.g., 302b and 302e. This relative measure of the relationship between two entities may be referred to as “relationship strength.”

In some situations, it may be helpful to describe social network 108, as depicted, using graph theory. In graph theory, there exists a set of vertices (e.g., entities 302a-302f) connected by a set of edges (relationships 304ab-304df), which may be represented by the equation, G=(V, E), where social network 108 or its equivalent graph (G) comprises a plurality of entities 302a-302f or vertices (V) and one or more relationships 304ab-304df or edges (E). Further, each relationship or edge within social network 108 may have a relationship strength or edge weight (Wᵢⱼ), where i and j represent the particular entities that are connected through the relationship.

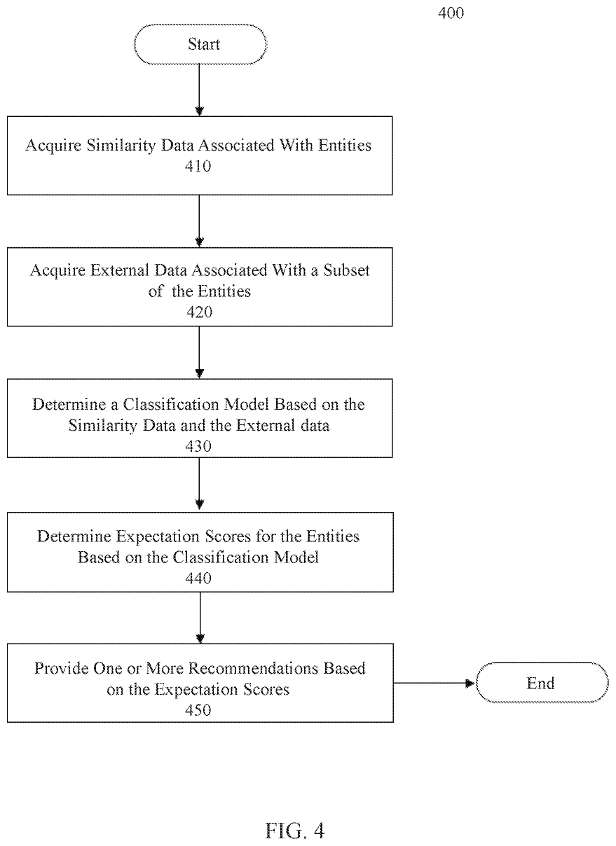

FIG. 4 is a flowchart of an exemplary process 400 for providing recommendations based on seeded supervised learning. For example, process 400 may be implemented by system 105, and more specifically, processor 210. Process 400 may include Steps 410-450 as described below. In some embodiments, relationship learning unit 212 may perform Steps 410-430 and recommendation unit 214 may perform Steps 440-450.

At Step 410, system 105 may acquire similarity data associated with a plurality of entities. Similarity data may be data indicative of or corresponding to a comparison between two or more entities. This comparison may be represented numerically. In some embodiments, similarity may include various data that is indicative of or corresponds to different types of comparisons. For example, similarity data may include data that is indicative of a communication frequency, a profile similarity, work similarity, a proximity similarity, exchange of currency similarity, recommended similarity, and/or the like.

A communication frequency may indicate the frequency or rate of communication between two entities. In some embodiments, a communication frequency may indicate that the entities communicate a number of times during a set period of time. For example, a communication frequency may indicate that the entities communicate once a month, twice a week, forty times a year, and so on. The communication frequency may also cover multiple forms of communication including calling, texting, instant messaging, email, etc. Further, the communication frequency may cover other forms of communication, such as posting information, comments, messages, videos, images, or the like. Two entities may have a communication frequency for each form of communication. In some embodiments, a communication frequency may also comprise a weighted and combined communication frequencies of multiple communication forms.

A profile similarity may indicate a comparison of how entities present themselves to the social network. For example, profile similarity may include a comparison of how two entities have changed a profile on a social network belonging to each entity over time. As another example, a profile similarity may include profile information (e.g., name, address, phone, education, work, interest, etc.) provided to the network by the two entities. Further, profile similarity may also include a comparison of different interactions that each entity has made on social network 108. This may include social media activities, such as liking pages, commenting on various posts, sharing posts, using emoticons, or the like.

Moreover, a work similarity may indicate a comparison of the professional careers of the entities based on information provided to social network 108. For example, a work similarity may include a comparison of the salaries, bonuses, taxes, job roles, job functions, professional networks, or the like.

Further, a proximity similarity may indicate a comparison of the geolocation of two entities provided to social network 108. The proximity similarity may include a comparison of geolocation taken at any time, place, manner, or any combination thereof. The comparison could be the distance between the two entities, the distance between the two entities and one or more reference points, the difference in speed between the two entities, or the like. The proximity similarity may also be captured using hardware or software, such as GPS and cellular tracking by a device owned by an entity.

Even further, an exchange of currency similarity may indicate a rate or amount of currency exchanged between two entities. The exchange of currency similarity can include one or more types of currency. For example, the exchange of currency may be one or more of internet currencies, such as Bitcoin, Litecoin, Peercoin, Ripple, Quark, etc. In some embodiments, the currency is real money (e.g. yuan, dollars, pounds, etc.) in various forms prescribing to a particular country. The exchange of currency similarity may also include a rate or amount of currency exchanged via red packet sharing, the process of distributing virtual envelopes of money, between two entities via the Internet. Father, the exchange of currency may indicate currency exchanged between two entities in different categories, such as gifts, payments, loans, etc.

A recommended similarity may indicate a comparison between services that two entities have recommended. These services could have been recommended by the entities to each other or to other entities on social network 108. The recommended similarity may indicate a comparison between services that two entities have recommended by category, such as non-profit/for-profit, technology, business, financial, products brought, etc. The recommended similarity may also indicate whether two entities have watched, skipped, commented on, liked, or shared the same one or more recommendations.

In some embodiments, system 105 may acquire similarity data directly from social network 108. In other embodiments, system 105 may acquire similarity data directly from a third-party source that has collected data associated with social network 108. Further, in alternative embodiments, system 105 may acquire similarity data from database 114, server 116, or cloud service 118.

At Step 420, system 105 may acquire external data associated with a subset of entities. The acquired external data may include data associated with external source 110 and/or data associated with a third-party source. The external data may include a page rank score for each entity in the subset of entities associated with an activity. The activity performed may include making a purchase, selling an item, joining a service, watching an advertisement, meeting at a location, or the like. The activity may be performed by an entity engaging with a business, software platform, device, etc. Engaging with, for example, a business may include viewings ads associated with the business, purchasing a product of the business, liking, sharing, viewing, or commenting on posts associated with the business, opening email from the business, or the like. Additionally, a page rank score for an entity may come from a graph-based algorithm, called PageRank, a technique originally used to rank websites by their relative importance on the web. Here, the page rank score for each entity may indicate how one entity is ranked relative to all of the entities having external data in relation to the performed activity.

In some embodiments, system 105 may acquire external data directly from external source 110. In other embodiments, system 105 may acquire external data directly from another source that has collected data associated external source 110. Further, in alternative embodiments, system 105 may acquire external data from database 114, servers 116, or cloud services 118.

At Step 430, system 105 may train a classification model based on the external data and the similarity data. System 105 may train the classification model using semi-supervised learning. Semi-supervised learning involves utilizing a small amount of known characteristics for a small amount of data (e.g., external data of the subset of entities) to predict the characteristics of a large amount of data (entities).

Here, utilizing graph theory nomenclature may be helpful. For example, as described above, social network 108 (G) comprises a plurality of entities 302a-302f(V) and one or more relationship 304ab-304df (E), and each relationship has a relationship strength denoted by (Wᵢⱼ), where i and j represent the particular entities that are connected by the relationship. It should be understood that the disclosed similarity data could also be identified using graph theory nomenclature. For example, since the similarity data may be data indicative of a comparison between two or more entities, then the similarity data may be a determination of a feature of the relationships or edges (E) between entities (V). Therefore, the similarity data or edge feature may be denoted as f_{e,i}, where e denotes the relationship 304ab-304df or edge and i denotes the particular type (e.g. communication frequency, etc.) of similarity data.

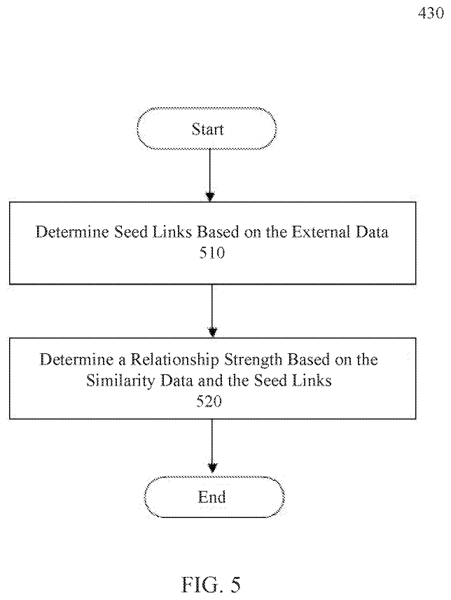

Turning to FIG. 5, a flowchart of an exemplary process for implementing Step 430 of FIG. 4 is provided, consistent with disclosed embodiments. At Step 510, system 105 may determine one or more seed links based on the external data. A seed link may represent the relationship between two or more seeds. Seeds are entities that have strong relationships with external sources. A seed link may have a characteristic (i.e., also known as a label of a seed link or edge), where the characteristic of the seed link may be either positive or negative. That is, a positive seed link may identify two seeds that have a strong relationship to each other while a negative seed link may identify two seeds that have a weak relationship.

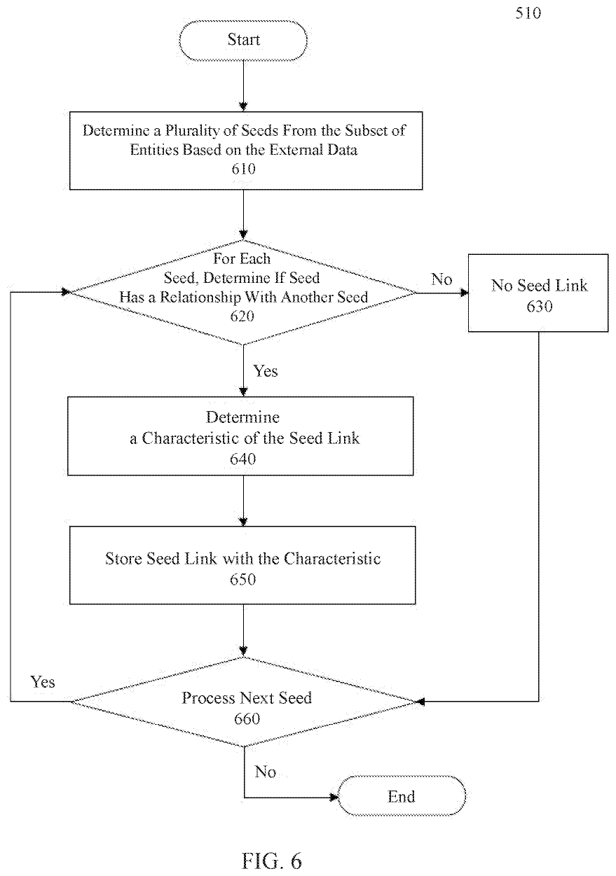

Referring FIG. 6, consistent with disclosed embodiments, a flow chart of an exemplary process for implementing Step 510 is provided. For example, at 610, system 105 may determine a plurality of seeds from the subset of entities based on the external data. Determining a plurality of seeds from the subset of entities, may involve system 105 comparing the external data for each entity to a threshold. For example, system 105 may compare an entity's page rank score associated with an activity to a threshold page rank score. In some embodiments, if the entity's page rank score exceeds or at least meets the threshold page rank score, then the entity is determined to be a seed. In those embodiments, if the entity's page rank score fails to exceed or at least meet the threshold page rank score, then the entity is not determined to be a seed. System 105 may also apply other techniques involving multiple page rank scores. For example, system 105 may compute a weighted average of page rank scores and compare the weighted average to a threshold to determine a seed.

At 620, system 105 may iteratively determine if a seed has a relationship with another seed. For example, system 105 can compare all combinations of seeds to find if a first seed has a subset of similarity data that overlaps with the similarity data of a second seed. If a seed shares a subset of overlapping similarity data with another seed, then it is determined that the seed has a relationship with the other seed. As another example, additional data such as a programming structure (linked list, hash map, array, etc.) that holds the relationships between the entities for social network 108 can be stored in memory 200. System 105 could search the programming structure to determine if a relationship exists between a first seed and a second seed. If a seed does not have a relationship with another seed, no seed link exists (Step 630) and system 105 may proceed to the next seed (Step 660).

However, if the seed does have a relationship with another seed, system 105 may determine a characteristic of the link (or seed link characteristic) between the seeds (Step 640). The characteristic of the seed link may be, for example, either positive or negative. For example, system 105 may utilize the external data along with a predetermined value to determine the characteristic of the seed link. In some embodiments, system 105 may determine the closeness of the external data for the linked seeds. For example, system 105 may compute the relative difference between the linked seeds and determine the characteristic of the seed link. For example, if the relative difference exceeds a predetermined value, such as a closeness tolerance threshold, system 105 may determine the characteristic of the seed link to be positive. However, if the relative different does not exceed the predetermined value, system 105 may determine the characteristic of the seed link to be negative. In other examples, the opposite may also be true, where system 105 may determine that the characteristic of the seed link is positive when the relative difference does not exceed a predetermined value or negative when the relative different does exceed a predetermined value.

In other embodiments, system 105 may determine a characteristic of the seed link. For example, if the maximum or minimum score between the two seeds exceeds a predetermined value, such as an indifference threshold, system 105 may determine the characteristic of the seed link as positive. However, if the maximum or minimum score between the two seeds does not exceed the predetermined value, system 105 may determine the characteristic of the seed link as negative. In other examples, the opposite may also be true, where system 105 determines the characteristic as positive if the maximum or minimum score between the two seeds does not exceed the predetermined value or negative if the maximum or minimum score between the two seeds exceeds the predetermined value.

Once system 105 determines the characteristic of the seed link (or seed link characteristic). System 105 may then store the seed link (650) as being positive or negative to be used later in step 520. After storing each seed link with its respective characteristic, system 105 may proceed to the next seed (Step 660) if one exists.

Turning back to FIG. 5, at Step 520, system 105 may determine the relationship strengths between the entities 302a-302f in social network 108 based on the similarity data and the seed links. System 105 may use a logistic regression to train a classification model to learn the relationship strengths or edge weights denoted by (Wₑ) for the plurality of entities 304a-304f based on the similarity data (f_{e,i}) and the characteristics (i.e., labels) of the seed links denoted by (ye). System 105 may train the classification model to compute one of more relationship strengths by way of the following mathematical representation.

$${min}_{z} {\sum }_{e} log ( exp ( - {y}_{e} ( {f}_{e}^{T} z ) ) + 1 )$$

The predicted relationship strength for any relationships (E) 304ab-304df with similarity data (f_{e,i}) not having a corresponding seed link may then be given by the following sigmoid function applied to the linear model.

$$\frac{1}{1 + exp ( - {f}^{T} z )}$$

Thus, the predicted relationship strength for a relationship may then be the probability of both seeds (i.e., entities or vertices) belonging to the external data. Returning to FIG. 4, at Step 440, system 105 may determine an expectation score of one or more entities based on the classification model. For example, system 105 may calculate an expectation score using an inbound-normalize PageRank function. The function may be presented as follows:

$${s}_{i}^{( t + 1 )} ← {\sum }_{j} {\hat{w}}_{ji} {s}_{j}^{( t )}$$

where the normalization function is:

$${\hat{w}}_{ji} = \frac{{w}_{ji}}{max ( {\sum }_{j} {w}_{ji} , 1 )}$$

It should be appreciated that the denominator of the normalization function has a maximum value of one, so that system 105 will not artificially magnify weak relationship strengths when the inbound relationship strength into an entity is small.

System 105 may also add a teleport probability vector (d) and a reset for strength or relationship (r) to the inbound-normalize PageRank function as described below.

s^{(t+1)}←diag(r)d+(l−diag(r))Ŵ^{T}s^{(t)}
where: Ŵ is a matrix of the strengths of relationships (Ŵji)

The teleport probability vector (d) and a reset for relationship strength (r) allows for system 105 to take in account randomness inherent in the inbound-normalize PageRank function if needed.

Further, at Step 450, system 105 may provide a recommendation based on the expectation score for one or more of the entities. A recommendation may be an advertisement, an invitation, a promotion or discount, an offer to buy something, or the like. A recommendation may be provided by a business, social network, entity, or the like. A recommendation may be for an activity. Again, the activity may include making a purchase, selling an item, joining a service, watching an advertisement, meeting at a location, or the like. The recommendation may be for external source 110 or for a product of external source 110. In some embodiments, system 105 may have acquired external data associated with the recommendation from external source 110. System 105 may provide the recommendation to the entities in a variety of ways. System 105 may provide the recommendation to the entities with the highest expectation scores, where the high expectation denotes an expectation of success for the targeted entity to view or engage with the recommendation. System 105 may provide the recommendations over a period of time. System 105 may also repeat Steps 410-440 to provide updated expectation scores at predetermined intervals or real-time. Further, system 105 may also repeat Steps 410-440 if the similarity data or the external data has changed. It should be understood that expectation scores may increase the accuracy of recommendation provided.

Descriptions of the disclosed embodiments are not exhaustive and are not limited to the precise forms or embodiments disclosed. Modifications and adaptations of the embodiments will be apparent from consideration the specification and practice of the disclosed embodiments. For example, the described implementations include hardware, firmware, and software, but systems and techniques consistent with the present disclosure may be implemented as hardware alone. Additionally, the disclosed embodiments are not limited to the examples discussed herein.

Computer programs based on the written description and methods of this specification are within the skill of a software developer. The various programs or program modules may be created using a variety of programming techniques. For example, program sections or program modules may be designed in or by means of Java, C, C++, assembly language, or any such programming languages. One or more of such software sections or modules may be integrated into a computer system, non-transitory computer-readable media, or existing communication software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps or inserting or deleting steps. It is intended, therefore, that the specification and examples be considered as exemplary only, with the true scope and spirit being indicated by the following claims and their full scope of equivalents.

1. A system for providing a recommendation to an entity, comprising:
a processor; and
a memory device storing instructions which, when executed by the processor, cause the processor to:
acquire, through a communication network, similarity data associated with a first entity, a second entity, and a third entity;
acquire, through the communication network, external data associated with the first entity and the second entity;
train a classification model based on the external data and the similarity data;
determine an expectation score of the third entity based on the classification model; and
provide, through the communication network, a recommendation based on the expectation score to the third entity.

2. The system of claim 1, wherein the first entity, the second entity, and the third entity are associated with a social network.

3. The system of claim 1, wherein the similarity data comprises data indicative of one or more of: a communication frequency, a profile similarity, a work similarity, a living similarity, a proximity similarity, an exchange of currency similarity, and a recommended services similarity.

4. The system of claim 1, wherein the external data includes a page rank score associated with an activity performed by both the first entity and the second entity.

5. The system of claim 1, wherein the processor is further configured to:
determine a characteristic of a seed link based on the external data, wherein the characteristic of the seed link is positive or negative;
determine a relationship strength based on the similarity data and the characteristic of the seed link.

6. The system of claim 5, wherein the processor is further configured to:
determine a first seed based on the external data of the first entity;
determine a second seed based on the external data of the second entity; and
determine that the characteristic of the seed link between the first seed and second seed is positive or negative based on the external data of the first entity, the external data of the second entity, and a predetermined value.

7. The system of claim 5, wherein the determined relationship strength is the relationship strength between the first entity and the third entity.

8. The system of claim 1, wherein the processor is further configured to:
determine an expectation score of a fourth entity based on the classification model wherein the similarity data is further associated with the fourth entity, and
wherein the expectation score for the third entity converges with the expectation score for the fourth entity.

9. The system of claim 8, wherein the processor is further configured to provide a recommendation to the fourth entity based on the expectation score of the third entity and the expectation score of the fourth entity.

10. The system of claim 1, wherein the recommendation is for an external source, and wherein the external source providing the external data.

11. A computer-implemented method for providing a recommendation to an entity, comprising:
acquiring, through a communication network, similarity data associated with a first entity, a second entity, and a third entity;
acquiring, through the communication network, external data associated with the first entity and the second entity;
training a classification model based on the external data and the similarity data;
determining an expectation score of the third entity based on the classification model; and
providing, through the communication network, a recommendation based on the expectation score to the third entity.

12. The method of claim 11, wherein the first entity, the second entity, and the third entity are associated with a social network.

13. The method of claim 11, wherein the similarity data comprises data indicative of one or more of: a communication frequency, a profile similarity, a work similarity, a living similarity, a proximity similarity, an exchange of currency similarity, and a recommended services similarity.

14. The method of claim 11, wherein the external data includes a page rank score associated with an activity performed by both the first entity and the second entity.

15. The method of claim 11, wherein the training the classification model based on the similarity data and the external data further comprises:
determining a characteristic of a seed link based on the external data, wherein the characteristic of the seed link is positive or negative;
determining a relationship strength based on the similarity data and the characteristic of the seed link.

16. The method of claim 15, wherein the determining the characteristic of the seed link further comprises:
determining a first seed based on the external data of the first entity;
determining a second seed based on the external data of the second entity; and
determining that the characteristic of the seed link between the first seed and second seed is positive or negative based on the external data of the first entity, the external data of the second entity, and a predetermined value.

17. The method of claim 15, wherein the determined relationship strength is the relationship strength between the first entity and the third entity.

18. The method of claim 11, further comprising:
determining an expectation score of a fourth entity based on the classification model wherein the similarity data is further associated with the fourth entity, and
wherein the expectation score for the third entity converges with the expectation score for the fourth entity.

19. The method of claim 18, further comprising providing a recommendation to the fourth entity based on the expectation score of the third entity and the expectation score of the fourth entity.

20. A non-transitory computer-readable medium that stores a set of instructions, when executed by at least one processor of a recommendation system, cause the recommendation system to perform a method for providing a recommendation to an entity, the method comprising:
acquiring similarity data associated with a first entity, a second entity, and a third entity;
acquiring external data associated with the first entity and the second entity;
training a classification model based on the external data and the similarity data;
determining an expectation score of the third entity based on the classification model; and
providing a recommendation based on the expectation score to the third entity.
